(19) United States
(12) Patent Application Publication
(10) Pub. No.: US 2011/0191627 A1
(43) Pub. Date: Aug. 4, 2011

(54) System And Method for Handling a Failover Event

(76) Inventors: Maarten Koning, Bloomfield (CA); Felix Burton, San Mateo, CA (US); Matt Sherer, Taos, NM (US)

(21) Appl. No.: 12/696,251

(22) Filed: Jan. 29, 2010

(51) Int. Cl. G06F 11/20; G06F 11/00

(52) U.S. Cl. 714/5.1; 714/10; 714/E11.071

(57) ABSTRACT

A system comprising a memory storing a set of instructions executable by a processor. The instructions being operable to monitor progress of an application executing in a first operating system (OS) instance, the progress occurring on data stored within a shared memory area, detect a failover event in the application and copy, upon the detection of the failover event, the data from the shared memory area to a fail memory area of a second instance of the OS, the fail memory area being an area of memory mapped for receiving data from another instance of the OS only if the application executing on the another instance experiences a failover event.

### BACKGROUND

Availability of a computer system refers to the ability of the system to perform required tasks when those tasks are requested to be performed. For example, if the system is part of a physical component such as a mobile phone, the tasks to be performed may be related to transmission and receipt of wireless signals or if the system is part of a car, the tasks may be related to braking or engine monitoring. If the system is unable to perform the tasks, the system is referred to as being down or experiencing downtime, i.e., as being unavailable. Downtime may be planned downtime event or unplanned downtime event, wherein both events may result in disrupting the operation of the system. Planned downtime events may include changes in system configurations or software upgrades (e.g., software patches) that require a reboot of the system. Planned downtime is generally the result of an administrative event, such as periodically scheduled system maintenance. Unplanned downtime may result from a physical event such as a power failure, a hardware failure (e.g., a failed CPU component, etc.), severed network connection, security breaches, operating system failures, etc.

A high availability (“HA”) system may be defined as a network or computer system designed to ensure a certain absolute degree of operation continuity despite the occurrence of planned or unplanned downtime. Within a conventional computer system, an HA level of service is typically achieved for a control processor through replicating, or “sparing”, the control processor hardware. This method involves selecting a primary control processor to be in an active state, servicing control requests, and a secondary control processor to be in a standby state, not executing control requests, but receiving checkpoints of state information from the active primary processor. When the primary processor undergoes a software upgrade, or fails, the secondary processor changes state in order to become active and services control request.

Once the primary processor subsequently reinitializes, it normally assumes the standby state and allows the secondary processor to continue as the active control processor until it undergoes as software upgrade or a system software failure. Due to the fact that at least one of the primary processor and the secondary processor may provide control service at any time, this type of architecture may enable a high level of availability. However, the cost of such an HA architecture is significant because the control processor must be replicated.

### SUMMARY OF THE INVENTION

A system comprising a memory storing a set of instructions executable by a processor. The instructions being operable to monitor progress of an application executing in a first operating system (OS) instance, the progress occurring on data stored within a shared memory area, detect a failover event in the application and copy, upon the detection of the failover event, the data from the shared memory area to a fail memory area of a second instance of the OS, the fail memory area being an area of memory mapped for receiving data from another instance of the OS only if the application executing on the another instance experiences a failover event.

A system comprising a memory storing a set of instructions executable by a processor. The instructions being operable to execute a first instance of an application on a first processor in an active state, the first processor generating checkpoints for the application, execute a second instance of the application on a second processor in a standby state, wherein the second processor consumes the checkpoints for the application, detect a failover event in the first instance of the application and convert, upon detection of the failover event, the second instance of the application on the second processor to the active state.

A processor executing a plurality of operating system (“OS”) instances, each OS instance executing a software application, the processor including a hypervisor monitoring the progress of the software applications executing in each OS instance and detecting a failover event in one of the OS instances, wherein the processor shifts execution of the application from the OS instance having the failover event to another one of the OS instances.

### BRIEF DESCRIPTION OF THE DRAWINGS

FIG. 1 shows an exemplary embodiment of a system in a virtualized environment for allowing failover between operating system (“OS”) instances through shared resources according to the exemplary embodiments.

FIG. 2 shows an exemplary embodiment of a method for providing a coverage analysis tool according to the exemplary embodiments.

FIG. 3 shows a further exemplary embodiment of a high availability system in a virtualized environment for allowing failover between two virtual processors without control processor replication according to the exemplary embodiments.

FIG. 4 shows an exemplary state diagram for processors operating according to the exemplary embodiments.

### DETAILED DESCRIPTION

The exemplary embodiments may be further understood with reference to the following description and the appended drawings, wherein like elements are referred to with the same reference numerals. The exemplary embodiments relate to systems and methods for achieving a high availability (“HA”) architecture in a computer system without physical processor hardware sparing. In other words, the exemplary systems and methods enables HA capability without replication of the control processor. Furthermore, the exemplary systems and methods may establish a virtualized environment that allows for failover between operating system (“OS”) instances (or states) may be performed through a share resource, while avoiding the need to synchronize state information and utilize bandwidth until a failure occurs.

As will be described in detail below, some exemplary embodiments are implemented via virtual processors. Thus, throughout this description, the term “processor” refers to both hardware processors and virtual processors.

As will be described below, the exemplary embodiments describe systems and methods to provide a failover mechanism between two or more nodes (e.g., processors, instances, applications, etc.) without requiring synchronization between the nodes until the point in time where a failure occurs. According to one exemplary embodiment, a virtual board may be created to establish the virtualized environment. This virtual board may allow for a virtual secondary control processor to take a small percentage of a system's central processing unit (“CPU”) in order to process checkpoints while in a standby state. These checkpoints may be transmitted to a primary (e.g., active) control processor that receives the majority of the CPU control time.

Failover may refer to an event where an active processor (e.g., a primary processor) is deactivated and a standby processor (e.g., a secondary processor) must activate to take on control of a system. More specifically, a failover may be described as the ability to automatically switch over to a redundant or standby processor, system, or network upon the failure or termination of an active processor, system, or network. In addition, unlike a “switchover” event, failover may occur without human intervention and generally without warning.

A computer system designer may provide failover capability in servers, systems or networks that require continuous availability (e.g., HA architecture) and a strong degree of reliability. The automation of a failover management system may be accomplished through a heartbeat cable connected to the two servers. Accordingly, the secondary processor will not initiate its system (e.g., provide control service) as long as there is a heartbeat or pulse from the primary processor to the secondary processor. The secondary processor may immediately take over the work of the primary processor as soon as any change or failure to detect the heartbeat of the primary processor. Furthermore, some failover management systems may have the ability to send a message or otherwise notify a network administrator.

Traditional failover systems require dedicated high bandwidth communication channels between nodes. In addition to the added hardware cost, the traditional failover infrastructure needs to heavily rely on these channels, thereby adding processing overhead. If the bandwidth over these channels is limited, this traditional system can increase the time required to complete a failover and may even limit the processing capabilities of each node in a non-failover scenario. For example, a primary node may always operate at 40% of processing capacity due to spending large amounts of time waiting for data to synchronize over the channels before initiating a job.

According to one traditional failover system, a failover application may receive a work item. The failure application may synchronize the work item to a failover node. However, the application must wait for an acknowledgement (or “ack”) from the node that the item has been received. Once the ack has been received, then the application may begin actual work on the item. Upon completion of the item, the application must notify the failover node of the complement and await an ack on the completion notification. Finally, the failover node acknowledges the completion notification. Meanwhile, during this entire process, continuous heartbeat messages must go over the communication to indicate liveliness. Thus, as described above, this traditional failover system requires extensive and continuous use of dedicated high-bandwidth communication channels between the failover application and the failover node.

As opposed to the traditional failover system, the exemplary embodiments will allow for all of the synchronization communication to be avoided. Specifically, the work that is performed in an area by a primary processor may be made available to other nodes (e.g., processors) in the system. However, this availability to other nodes may be limited to periods of existing failover (e.g., failover scenarios). Additionally, heartbeat-style messages may be performed in a more lightweight manner using a local “hypervisor”, as opposed to overloading the failover communication channels.

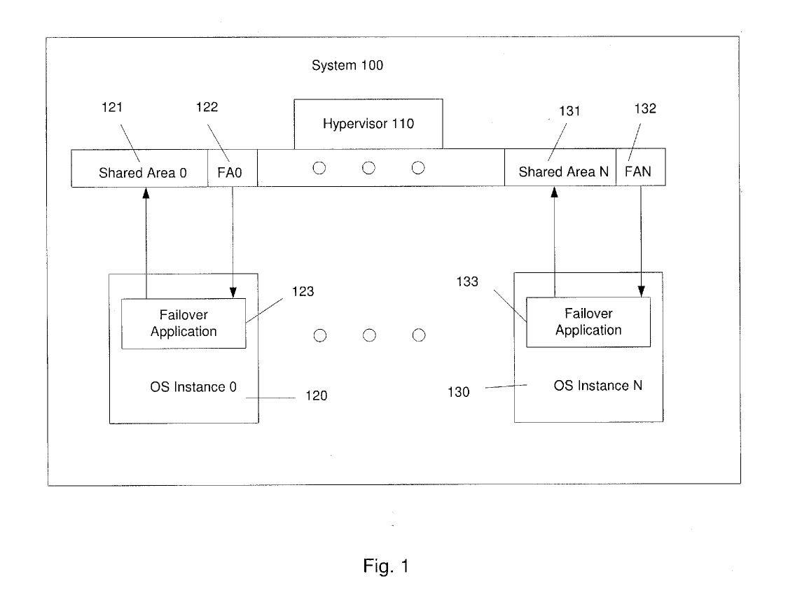

FIG. 1 shows an exemplary embodiment of a system 100 in a virtualized environment for allowing failover between operating system (“OS”) instances through shared resources according to the exemplary embodiments. The system 100 may provide a failover mechanism between two nodes, or applications, without requiring synchronization between the nodes until the point in time in which the failure occurs. Accordingly, the communication between the nodes may be limited in order to conserve bandwidth usage. The communication may be accomplished via an Ethernet connection, a high-speed serial connection, etc.

The exemplary system 100 may further include a plurality of OS instances, such as OS instance 0 120 through OS instance N 130. Each of the OS instances 120 and 130 may include a failover application 123 and 133 respectively. Accordingly, each of the failover applications 123 and 133 may be in communication with a shared memory area 121 and 131 respectively. It should be noted that while FIG. 1 illustrates two OS instances 120 and 130, the exemplary system 100 may include any number of additional OS instances.

The shared memory areas 121 and 131 may be described as mapped areas that are visible to its specific OS instance 120 and 130 for storing transaction data while the instance is in progress. In addition to storing current transaction data, the shared areas 121 and 131 may store “acks” of work packets. In other words, each application 123 and 133 may place data related to a current transaction in its respective shared area 121 and 131 until the work is complete. At that point, the work packets may either be removed from the shared area or flagged as being complete, thereby allowing the area to be reused.

Each of the failover applications 123 and 133 may also be in communication with fail area, such as FA0 122 for OS instance 0 120 and FAN 132 for OS instance N 130, etc. The FA0 122 through FAN 132 may be described as mapped areas of memory where pending work from another node (e.g., OS instance) may be placed if that node fails. For example, open work packets from OS instance 1 (not shown) may be placed within FA0 122, and thus, may be failed over to the OS instance 0 120 upon failure of the OS instance 1. Therefore, OS instance 0 120 may only receive the additional failover tasks on the failure of the other nodes in the network. Thus, bandwidth and synchronization requirements may be minimized and/or avoided.

According to the exemplary embodiments, data and code needing failover may be stored locally within the respective areas, FA0 122 through FAN 132. Virtualization techniques may allow for in-progress data to be stored in some of these known locations. If a failure occurs, then the current work set may be replicated to the failover nodes (e.g., OS instances 0 120 through OS instance N 130). In a virtualized environment, a hypervisor 110 may be used for transferring data, or work packets, from one OS instance (e.g., 120) to another OS instance (e.g., 130). Specifically, the hypervisor 110 may refer to a hardware or software component that may be responsible for booting an individual OS instance (or state), while allowing for the creation and management of individual shared memory areas (e.g., 121 and 131) specific to each OS instances (e.g., 120 and 130, respectively). Generally, these shared areas 121 and 131 may be visible to another OS instance, or may be only visible via the efforts of the hypervisor 110 when a failure occurs. Accordingly, data may be handed off by the hypervisor 110 upon the occurrence of a failure. As will be described in greater detail below, the transfer of data by the hypervisor 110 may be reduced to just a change of mappings.

While the exemplary embodiment of the system 100 may be implemented within a virtualized scenario, it should be noted that alternative embodiments may include physically separate nodes (e.g., the system 100 is not necessarily in a virtualized environment). According to this alternative embodiment, the work flow may be very similar, however rather than the hypervisor copying data over shared memory, an agent (not shown) may utilize an existing channel to copy the local FAN data to a remote node within a cluster. If the nodes (e.g., the OS instances 0-N, 120 through 130) are physically separate, the replication of the current work set may be accomplished over standard Ethernet communication.

In either case (e.g., local or remote), no additional hardware is required. Communication channels needed for basic OS functionality, such as Ethernet communication, may be used to synchronize any outstanding tasks to the failover nodes (e.g., FA0 122 through FAN 132). Accordingly, the exemplary system 100 may reduce the overall complexity and cost from a traditional failover system. Additionally, it should be noted that a failover node, such as the OS instance 0 120, may traditionally be an idle failover node, the exemplary system 100 allows for the OS instance 120 to perform functional work and only receive the additional failover tasks upon the failure of another node in the system 100.

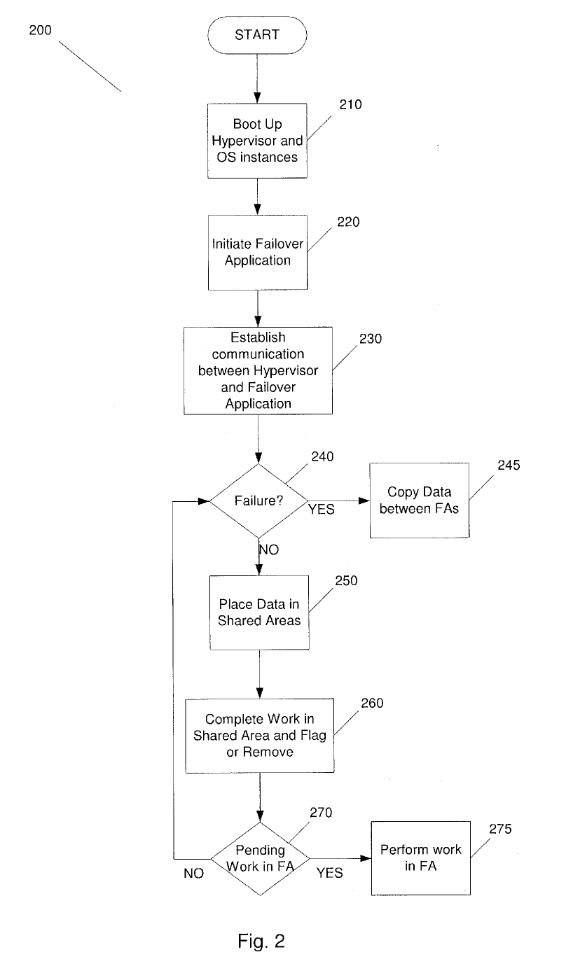

FIG. 2 shows an exemplary embodiment of a method 200 for allowing failover between operating system (“OS”) instances through shared resources according to the exemplary embodiments. Accordingly, the method 200 may describe a general pattern of workflow on the processing works of the system 100 detailed in FIG. 1.

In step 210 of the method 200, the hypervisor 110 and the OS instances, such as OS instance 0 120 through OS instance N 130, may be booted up. This boot up may vary based on OS and/or hardware, however the end result may be that two or more OS instances are booted sharing the hardware. As described above, the hypervisor 110 may manage the hardware access for the OS instances 120 and 130.

In step 220, a failover application, such as failover application 123 may initiate work. Once initiated, in step 230 the failover application 123 may establish communication with the hypervisor 110 via the OS. Specifically, the failover application 123 may request mapped areas from the hypervisor 110 in which to do work. This mapped area may include the shared memory area 121 designated for OS instance 0 120, and may further include the fail area, such as the FA0 122, for any pending work from any of the other OS instances (e.g., OS instance N 130).

In step 240, while the failover application is in communication with the hypervisor 110, the hypervisor 110 may determine whether a failure has occurred. Specifically, the hypervisor 110 may monitor the activities of the OS instances 120 through 130 to ensure that progress is being made. Therefore, the monitoring of the OS instance 120 by the hypervisor may be performed during any of the steps 210-275 depicted in FIG. 2.

It should be noted that there are various methods in which the hypervisor 110 may detect that a failure has occurred at one of the OS instances. For example, the hypervisor 110 may use a progress mechanism to determine if the OS instance, or an application, is dead. This may be feasible by observing core OS information such as uptime statistics, process information, etc. As an alternative, the OS instance may execute specific privileged instructions in order to indicate progress, as well as the completeness of work packets. Accordingly, these instructions may be provided to the hypervisor 110 to detect the occurrence of a failure. As a further alternative, the OS (or a checking application) may observe a specific application in question and place a request to the hypervisor 110 to copy the shared data from the local fail area (e.g., FAN 132) to a remote fail area (e.g., FA2 (not shown)). Regardless of the method in which the hypervisor 110 detects a failure, it is important to note that no work packets may be synchronized until the occurrence of a failure. Upon the detection of the failure, the method 200 may advance to step 245. However, if no failure is detected, the method 200 may then advance to step 250.

In step 245, the hypervisor 110 may copy data between each of the fail areas, such as FA0 122 through FAN 132. Accordingly, the hypervisor 110 may take appropriate action if a failure occurs in a specific OS instance during step 270 of the method 200. For example, upon failure in OS instance 120, the hypervisor 110 may take any pending work in the shared memory area 121 and transfer the work to a fail area of another node in the system 100, such as FAN 132 of the OS instance 130. In addition or in the alternative, that specific OS instance 120 may be capable of transferring its work in the shared memory area 121 to a fail area, such as FAN 132.

Therefore, whether performed by the hypervisor 110 or the OS instance 120, all of the data may be moved to a specific fail area (e.g., one of the FA0 122 through FAN 132) of another OS instance. More generally, each of the applications on each of the OS instances may request the periodic movement of pieces of data, thereby allowing for a more granular failover. For example, the exemplary system 100 may have three OS instances (e.g., 0, 1, and 2). The hypervisor 110 may move a third of any current pending work to each of the OS instances. Therefore, 33% of the pending work may be placed in the fail area FA0 for OS instance 0, 33% in fail area FA1 for OS instance 1, and 33% in fail area FA2 for OS instance 2. Thus, this method of distributing the pending work may allow for dynamic load balancing.

In step 250, the failover application 123, as well as the further failover applications (e.g., failover application 133, etc.) may place its respective work packets into its designated shared memory areas, such as area 121 for failover application 123, area 131 for failover application 133, etc. These work packets may be related to a current transaction of the OS. Once the work packets are placed in these shared areas, the failover applications 123, 133 may perform work on the packets using a transaction model. Specifically, the OS instance 120 may be in an active state and process the data accordingly. Thus, the OS instance 120 may service control requests as per normal operation.

In step 260, the failover application 123 may complete the work on the packets within the designated shared area 121. At this point the completed packets may either be removed from the shared area 121 or simply flagged a completed data. According to the exemplary embodiments, the removal, or flagging, of data by the failover application 123 may allow for the reuse of the space within the shared area 121.

In step 270, the failover application 123 may check its respective fail area, namely FA0 123, for any pending work from one of the other OS instances (e.g., a failing node). Accordingly, each of the failover applications (e.g., failover applications 123 through 133) may perform a determination in step 270 as to whether pending works exists in its fail area (e.g., FA0 122 through FAN 132). If there is pending work in the fail area FA0, then the method 200 may advance to step 275, wherein the failover application 123 may perform the pending work packets within the FA0 122. However, if there is no remaining work packets, then the method 200 may return to step 220, wherein the failover application 123 may initiate any further work within its respective shared memory area 121. In other words, the failover application 123 and the OS instances 120 may continue to operate as normal.

It should be noted that additional failover applications, such as failover application 133, may perform a similar operation as method 200 for the required work in the FAN 132. As described above, work that is performed in this FAN 132 may be made available to other nodes (e.g., the other OS instances) in the system 100. However, the availability of this work may be limited to only failure scenarios. Additionally, heartbeat-style messages may be accomplished in a more lightweight manner using the hypervisor 110, as opposed to overloading a failover communication channel.

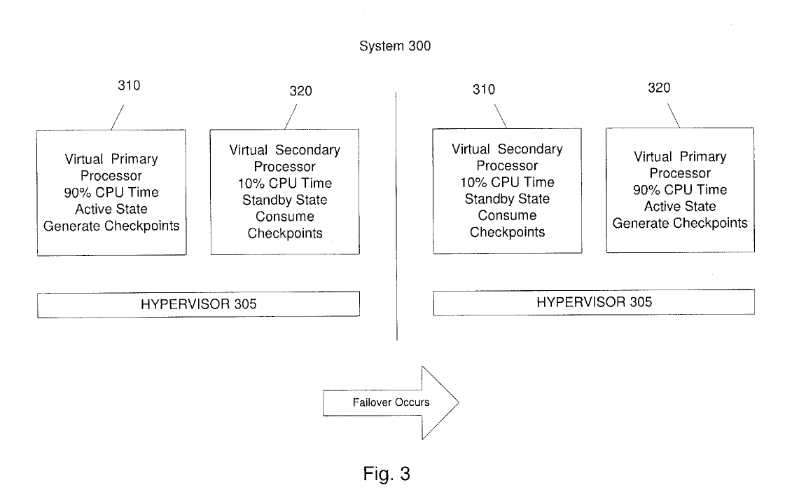

FIG. 3 shows a further exemplary embodiment of a high availability (“HA”) system 300 in a virtualized environment (e.g., on a virtual board) for allowing failover between two virtual processors without control processor replication according to the exemplary embodiments. Accordingly, this system 300 may be an additional embodiment or alternative embodiment of the system 100 described in FIG. 1. Specifically, the exemplary system 300 may utilize a single hardware processor to “virtualize” the sparing typically performed on multiple hardware processors. In the event of a failover (e.g., software faults, insufficient memory, application driver errors, etc.), a virtual instance may be in standby, ready to take control of the processing duties. Thus, the exemplary system 300 does not necessitate any additional hardware in order to provide an HA level of service.

The HA system 300 may be created on a virtual board which includes a system supervisor (e.g., hypervisor 305) having processor virtualization capabilities. The HA system 300 may further include both a primary control processor 310 in an active state and a secondary control processor 320 in a standby state. However, as described above the primary control processor 310 and secondary control processor 320 may be virtualized processors and therefore do not require any additional hardware components to implement the exemplary embodiments. That is, the current physical layout of the system, whether the system has a single hardware processor or multiple hardware processors may be unchanged when implementing the exemplary embodiments. The secondary control processor 320 may be given a small percentage of the processing time (e.g., “CPU time”) in order to process checkpoints while in the standby state. These checkpoints may be received from the active primary control processor 310 as the primary processor 310 is provided with the majority of the CPU time. It should be noted that while the exemplary system 300 is illustrated to include two virtual processors 310 and 320, the present invention may be applied to any number of virtual processors. Furthermore, the present invention may apply to systems having multiple hardware processors.

As opposed to replicating (or “sparing”) a control processor hardware onto a second control processor hardware, the system 300 allow for an HA architecture to be achieved with a single processor, without physical processor hardware sparing. For example, prior to the occurrence of a failover event, the virtual primary processor 310 may be in active state and receive a substantial portion of the processing time, such as 90% CPU time. Furthermore, the primary processor 310 may generate system checkpoints to be received by the virtual secondary processor 320. At this point, the virtual secondary processor 320 may be in a standby state and receive a small portion of the processing time, such as 10% CPU time.

According to this example, the system supervisor (e.g., hypervisor 305) may detect the occurrence of a failover event at the primary processor 310 and adjust the CPU time percentages and the states of the virtual processors 310 and 320. (Examples of a hypervisor detecting a failover event were provided above). Specifically, the virtual primary processor 310 may be switched, or converted, to a standby state and the CPU time may be reduced to 10%. Conversely, the virtual secondary processor 320 may be switched to an active state and the CPU time may be increased to 90%. Furthermore, the secondary processor 320 may now generate checkpoints to be received and consumed by the primary processor 310.

Accordingly, the exemplary system 300 may allow for a HA architecture without replication of processor hardware. Specifically, the virtual board including at least the primary processor 310 and the secondary processor 320 may provide significant improvements in the overall availability of the system 300. Furthermore, without physical processor sparing, the exemplary system 300 may provide hitless software migrations. For example, a current software version or application may continue to execute on the primary processor, while a new version or application may be loaded onto the secondary processor. After that loading is complete, the secondary processor with the new version or application can become the primary processor executing the new version or application. The processor that has then become the secondary processor may then be loaded with the new version or application, thereby allowing software migrations without any downtime for the system.

It should be noted that this exemplary system 300 may apply to hardware having multiple processors. In other words, the system 300 may provide a similar software execution environment for HA software designed for physical processor sparing. For example, a high percentage of all processors may be used for normal operations during a primary operation. Upon the detection of a failure event (or software upgrade), this percentage may be shifted to a secondary operation. Alternatively, some of the processors may be virtualized, while other processors may be used directly for normal operation during the primary operation. Upon the detection of a failure event (or software upgrade), this percentage may be shifted to a secondary operation for the virtualized processors while the physical processors are converted to the secondary operation.

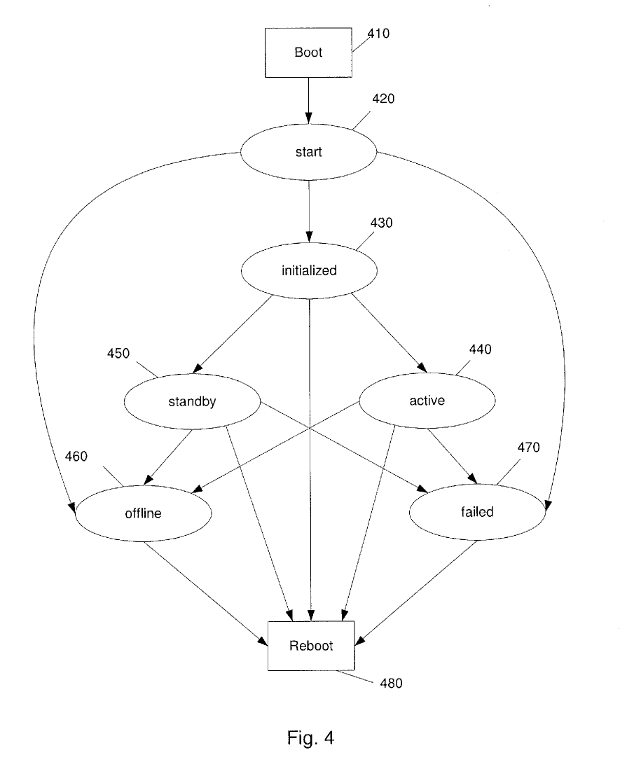

FIG. 4 shows an exemplary state diagram for the processors 310 and 320 of FIG. 3. These states describe the operation of the processors as various events occur during operation. As described above, the states described herein may be applicable to a single hardware processor environment or a multiple hardware processor environment. In states 410 and 420, the processors are booted and started, respectively. In state 430, the processors are initialized. One of the processors is initialized as the primary (or active) processor as shown by state 440, while the other processor is initialized as the secondary (or standby) processor as indicated by state 450. If the above example of initialization were followed, the result may be the left hand side of FIG. 3, i.e., processor 310 is initialized as the primary processor and processor 320 is initialized as the secondary processor. However, those skilled in the art will understand that the opposite scenario may also occur.

It should also be noted that when the processors are initialized, other states are also possible such as the offline state 460 or the failed state 470. For example, the processor may experience a hardware or software failure upon initialization and therefore the processor goes immediately to the failed state 470. In another example, the user may have to take administrative action on the processor and therefore instructs the processor to go into the offline state 460 upon initialization. Those skilled in the art will understand that there may be many other reasons for such states to exist.

Returning to the more common scenario, i.e., processor 310 is in the primary (active) state 440 and processor 320 is in the secondary (standby) state 450. In this scenario, the processors 310 and 320 will operate as described in detail above, e.g., the processor 310 in the active state will use approximately 90% of the CPU time and the processor 320 in the standby state will occupy approximately 10% of the CPU time and consume checkpoints generated by the active processor. However, at some point the primary processor 310 will transition to another state where it will, not be the primary processor, e.g., failed state 470, offline state 460 or reboot state 480. As described above, there may be many reasons for the primary processor 310 to transition to these states. When such a transition occurs, the hypervisor 305 will transition the secondary processor 320 from the standby state 450 to the active state 440. Thus, the processor 320 will become the primary (active) processor and the processor 310 will become the secondary (standby) processor as depicted on the right side of FIG. 3. Those of skill in the art will understand that the processor 310 may have to transition from the new state (e.g., failed state 470) to reboot state 480 and back through the start 420 and initialization state 430 to get to the standby state 450. However, after such transitioning occurs, the result will be as described above.

Those skilled in the art will also understand that the above described exemplary embodiments may be implemented in any number of manners, including, as a separate software module, as a combination of hardware and software, etc. For example, hypervisor 110 may be a program containing lines of code that, when compiled, may be executed on a processor.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

1. A system comprising a memory storing a set of instructions executable by a processor, the instructions being operable to:
monitor progress of an application executing in a first operating system (OS) instance, the progress occurring on data stored within a shared memory area;
detect a failover event in the application; and
copy, upon the detection of the failover event, the data from the shared memory area to a fail memory area of a second instance of the OS, the fail memory area being an area of memory mapped for receiving data from another instance of the OS only if the application executing on the another instance experiences a failover event.

2. The system of claim 1, wherein the instructions are further operable to:
instruct the second OS instance to execute the data copied to the fail memory area.

3. The system of claim 1, wherein the monitoring is performed by a progress mechanism observing core operating system statistics of the first OS instance.

4. The system of claim 1, wherein one of the first OS instance and the software application execute privileged instructions to indicate progress.

5. The system of claim 1, wherein the instructions are further operable to:
receive a request from a failover application executing on the second OS instance to copy at least a portion of the data from the fail memory area of the second OS instance to a fail memory area of a further OS instance.

6. The system of claim 1, wherein the selection of the fail memory area of the second OS instance for copying the data to is based on a set of rules.

7. The system of claim 1, wherein the monitoring, detecting and copying are performed by an agent in a software environment having remote nodes, the agent utilizing an existing communication channel to copy the data from the shared memory area to the fail memory area of the second OS instance.

8. A system comprising a memory storing a set of instructions executable by a processor, the instructions being operable to:
execute a first instance of an application on a first virtual processor in an active state, the first virtual processor being mapped to a physical processor, the active state occupying at least a predetermined amount of processing time of the physical processor, the first processor generating checkpoints for the application;
execute a second instance of the application on a second virtual processor in a standby state, the second virtual processor being mapped to the physical processor, the standby state occupying a remaining processing time of the physical processor, wherein the second processor consumes the checkpoints for the application;
detect a failover event in the first instance of the application; and
convert, upon detection of the failover event, the second instance of the application on the second processor to the active state.

9.-11. (canceled)

12. The system of claim 8, wherein the instructions are further operable to:
execute a further instance of the application on the first virtual processor in the standby state, the first processor consuming checkpoints generated by the second virtual processor executing the second instance of the application.

13. The system of claim 8, wherein the detecting is performed by a hypervisor.

14. A processor executing a plurality of operating system (“OS”) instances, each OS instance executing a software application, the processor including a hypervisor monitoring the progress of the software applications executing in each OS instance and detecting a failover event in one of the OS instances, wherein the processor shifts execution of the application from the OS instance having the failover event to another one of the OS instances, and wherein the shifting of the execution includes copying, upon the detection of the failover event, data from a shared memory area of the OS instance having the failover event to a fail memory area of the another one of the OS instances.

15. (canceled)

16. The processor of claim 14, wherein the another one of the OS instances includes a failover application that monitors the fail memory area and instructs the another one of the OS instances to execute the application with the data from the fail memory area.

17. The processor of claim 14, wherein the shifting of the execution includes converting, upon detection of the failover event, the OS instance having the failover event from an active state to a standby state and converting the another OS instance from a standby state to an active state.
